(19) United States
(12) Patent Application Publication
(10) Pub. No.: US 2008/0016463 A1
(43) Pub. Date: Jan. 17, 2008

(54) SYSTEMS AND METHODS FOR USING A SWITCH TO CONTROL A COMPUTER

(75) Inventor: Randal J. Marsden, Edmonton (CA)

Correspondence Address: BLACK LOWE & GRAHAM, PLLC, 701 FIFTH AVENUE, SUITE 4800, SEATTLE, WA, 98104, US

(73) Assignee: MADENTEC (USA) INC., Kaysville, UT (US)

(21) Appl. No.: 11/777,785

(22) Filed: Jul. 13, 2007

Related U.S. Application Data
(60) Provisional application No. 60/807,444, filed on Jul. 14, 2006.
(60) Provisional application No. 60/824,557, filed on Sep. 5, 2006.

(51) Int. Cl. G06F 3/02

(52) U.S. Cl. 715/814; 345/170; 715/856

(57) ABSTRACT

Software and graphical user interfaces for controlling a personal computer system using one or more switches, or alternative pointing devices. When a highlight or a cursor is over a desired display item, a fill indicator is displayed. The fill indicator provides a visual indication of how long the highlight or cursor are colocated with the item. A selection of the item is made by either the user activating a switch(es) or a fill indicator reaching a limit.

### PRIORITY CLAIM

This invention claims the benefit of U.S. Provisional Application No. 60/807,444 filed on Jul. 14, 2006 and Application No. 60/824,557 filed on Sep. 5, 2006 both of which are incorporated by reference in their entirety herein.

### BACKGROUND OF THE INVENTION

Many people, including people with disabilities, are unable to use a physical keyboard or mouse to control a computer. Since the mid-1980's, numerous alternative access methods have been devised, including using alternatives to the keyboard and mouse. For example, alternative head pointers replace the function of the mouse by allowing the user to simply move their head to control the computer's cursor. As another example, a single switch (or switches) are used to control scanning software on the computer. These methods, have opened the world of computing and the internet to many who otherwise would not be able to use a computer.

With respect to people using alternative pointing devices, such as head pointers, selecting or “clicking” can often be a problem. For example, consider people with high level spinal cord injuries who only have voluntary control of their body from the neck up. While they can move their head to control the cursor, the problem becomes “how do they click?”. For some, an external switch is the answer; they can actuate specialty switches by sipping or puffing on a tube, blinking, puffing out their cheek, or even clicking their teeth together. For others, clicking an external switch is not possible. For them, another option for selecting an on-screen item is to “dwell” on it, or place the cursor over the item for a specified period of time. In this way, only cursor movement is required to point to, and select an item.

One problem with dwell selection techniques is the lack of feedback for the user to know when exactly a selection will take place. Because the action is passive, they don't have direct control over when the selection will occur. They simply must move the cursor and wait, learning from experience when the timing of the dwell will result in a selection. This can often result in unintended selections being made. See FIG. 1

Another problem with dwell selection techniques is they often require the user to be very precise in pointing and positioning the computer's cursor. Many people with disabilities, such as people with Cerebral Palsy, have a difficult time holding their head still enough to keep the cursor over a desired item for the prescribed dwell time. Even though they can generally direct the cursor in the desired direction, they can't hold still long enough to perform a selection.

Still other people with disabilities can't control an alternative-pointing device at all. However, almost all of these types of people with disabilities can somehow actuate a switch or multiple switches. Special computer software has been developed that accepts this user input and converts it into computer control via a method known as “scanning”. When using a single switch, this scanning typically involves a highlighted indicator automatically moving from selection to selection of items displayed on the screen of the computer with a preset timing or cadence, usually in a row-column array. When the highlighted indicator arrives at the desired item, the user actuates their switch to select that item. The rate at which the highlighted indicator moves from item to item is typically set to accommodate the users' abilities. This type of computer input can be very slow, considering much time is wasted in waiting for the highlighted indicator to make its way to the desired item.

In an effort to increase the efficiency of switch access, systems have been developed that take advantage of two-switch input. For users who are able to control two separate switches, this approach can be much faster as it is more direct. The first switch advances the highlighted indicator while the second switch is used to select. Similarly, three-switch methods can be used where the first switch advances the highlighted indicator, the second switch backs-up the highlighted indicator, and the third selects. These methods are much faster than single-switch scanning because they are more direct: the user manually advances the highlighting, rather than having to wait for it to be done automatically by the computer.

Numerous systems have been develop to help speed input by limiting the number of items to be scanned. Baker et al., in U.S. Pat. Nos. 5,097,425 and 5,297,041, describe a predictive scanning input system that limits the choices of items according to items already selected (used commonly when retrieving a pre-stored message). King et al., in U.S. Pat. Nos. 5,953,541, 6,011,544, 6,286,064, 6,307,548, 6,307,549, 6,636,162, 6,646,573 describe a system for disambiguating ambiguous input sequences that allows the required number of selection areas to be much smaller by allowing more than one item per selection area. These systems have helped tremendously in speeding the scanning process by limiting the number of items being scanned.

### SUMMARY OF THE INVENTION

The present invention provides software and graphical user interfaces for controlling a personal computer system using one or more switches, or alternative pointing devices. Switches are connected to the computer via a switch interface (typically through a USB port). Switch signals are sent by the switch interface driver software on the computer to assistive technology software that converts them into signals for command and control of the computer. The assistive software accomplishes this by presenting alternative visual representations of commands to the user, typically including an array of choices that are scanned by a visual highlight. When the highlight is over the desired the command, the user actuates the switch(es), and the assistive software executes the associated command. In this manner, all keyboard, mouse, and computer commands can be accomplished using one or more discrete switches. Systems and methods are described that provide visual and audible cueing to help make selection of desired items more direct, thus increasing speed and efficiency.

### BRIEF DESCRIPTION OF THE DRAWINGS

The preferred and alternative embodiments of the present invention are described in detail below with reference to the following drawings:

FIG. 1 illustrates a front view of a computing device having a display with an on-screen keyboard with graphical user interface formed in accordance with an embodiment of the present invention;

FIGS. 2 and 3 illustrate alternate embodiments of graphical user interfaces formed in accordance with an embodiment of the present invention; and

FIG. 4 illustrates an example process performed by the system of FIG. 1 or similar systems.

### DETAILED DESCRIPTION OF THE PREFERRED EMBODIMENT

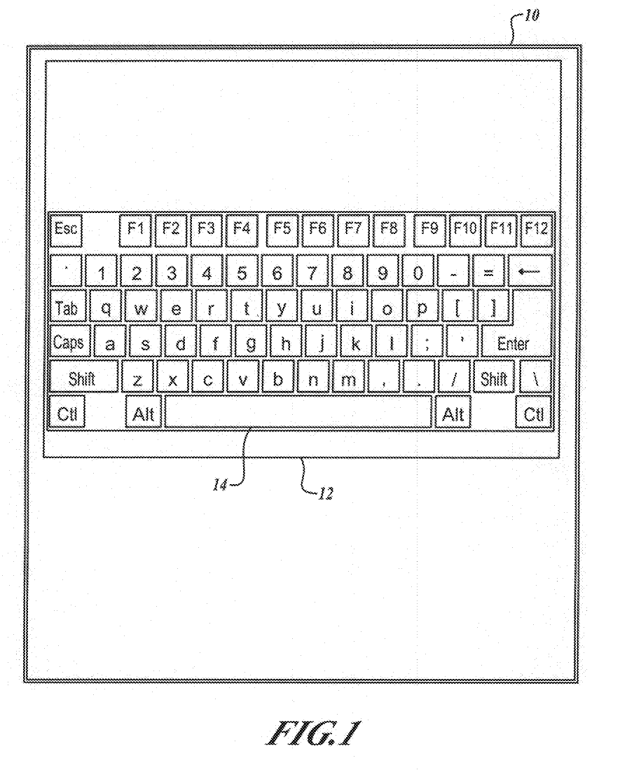

FIG. 1 illustrates an example of computing device 10 that includes a display 12. The computing device 10 includes memory for storing application programs and a processing device for executing stored application programs. An application program when executed by the processing device presents keyboard 14 on the display 12. User interfaces devices (not shown) such as singular multiple switches, or any of the number of cursor control devices may be used. Examples of a user interface that performs cursor control are alternative pointing devices, such as a head pointer.

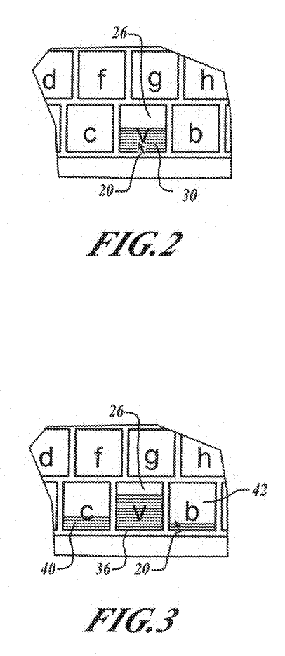

The processing device performs selection of items or keys on the on-screen keyboard 14. Based upon an analysis of movement of the cursor over the respective keys. Examples of the various selection methods are described below. FIG. 2 shows a partial screen shadow from one embodiment of the present invention. The application program being executed by the processing device controls movement of a cursor 20, based on cursor control signals generated by the user interface that are sent to the computer device 10. As the cursor 20 is positioned over a key 26, such as the “v” key, the key 26 begins to “fill up” with a dwell indicator 36. The dwell indicator 36 may be an alternate color or some visualization that is different than what is already present within the key 26. In one embodiment, the dwell indicator 30 moves from the bottom of the key 26 to the top of the key 26 thereby simulating filling of a glass with a liquid. When the dwell indicator 30 reaches the top of the key 26, the key 26 is selected. In other embodiments, the dwell indicator 30 moves left-to-right, right-to-left, top-to-bottom, middle-to-outside radially, or outside-to-middle radially. The selection takes place when the dwell indicator 30 reaches the respective end of its fill area or a threshold amount of fill has occurred.

FIG. 3 shows a partial screen shot of another embodiment of the present invention. For some users, it is difficult to hold the cursor 20 over the key 26 until dwell indicator reaches the predefined threshold, i.e., fills up. These users often cause the cursor 20 to drift on and off the key 26 while trying to select it. To accommodate this behavior, the processing device records and stores how long the cursor 20 dwells on a key over a set period of time (“cumulative dwell”). As the cursor 20 passes over the key 26, the key 26 begins to fill up with a dwell indicator 36. If the cursor 20 leaves the key 26 the key 26 retains its fill level for a specified period of time. After the specified period of time, the dwell indicator 36 begins to decay (drain) until the key 26 no longer has any fill. However, if the cursor 20 returns over the key 26, the key will once again begin to fill from whatever is the present fill state.

As shown in FIG. 3, the cursor 20 has hovered over the three keys 40, 26, 42 (c, v and b keys respectively). The cursor 20 has hovered over the v-key 36 the longest, since its fill level is the highest. The user may guide the cursor 20 back and forth over the v-key 36. Each time the cursor 20 passes over the v-key 36 the fill level (the dwell indicator 36) increases eventually filling the key 26 to the top, thus producing a selection action. The adjacent keys 40, 42 may also fill, but not as fast as the v-key 26, depending upon the amount of time the cursor 20 is within the regions associated with the keys 40, 42. After a key is selected, all fill levels of all keys are reset to zero (or empty). The dwell indicator shown in FIG. 3 may have various formats such as that described above for FIG. 2.

Algorithmic variables that may be preset or set by the user in the present invention include the following:

BEGIN DELAY: the time in which the cursor must be within a key boundary before the key begins to fill;

FILL TIME: after the Begin Delay has occurred, the time in which the cursor must be within a key boundary in order for the fill level to reach the top and the key selected;

PERSISTENCE TIME: the time the fill level remains the same after the cursor leaves a key boundary; and

DECAY TIME: after the Persistence Time has occurred, the time in which the cursor must be outside of a key boundary in order for the fill level to decay to zero.

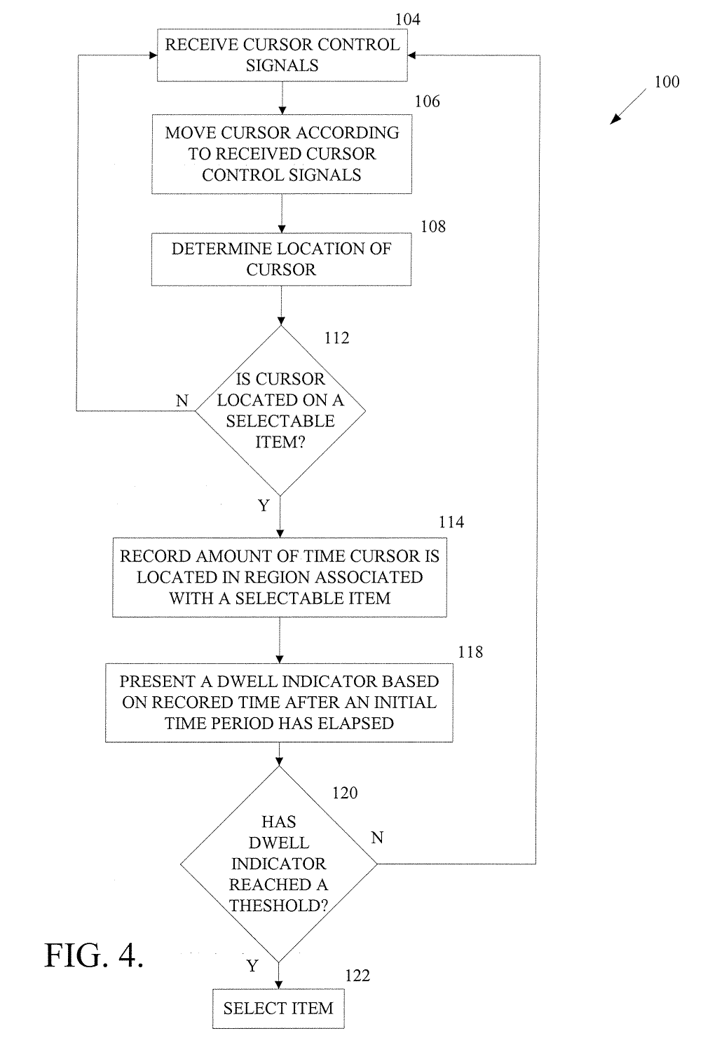

FIG. 4 illustrates an example process 100 performed by the computing device 10 of FIG. 1. First at a block 104 pressure control signals are received from a cursor control device or switch that is in signal communication with the processing device. Next at a block 106, the processing device moves the cursor according to the received cursor control signals. Next at a block 108, the processing device determines the location of the cursor. At a decision block 112, the processor determines if the cursor is located on a selectable item, typically included within an on-screen keyboard. If the cursor is not located on a selectable item the process 100 returns to the block 104. If the cursor is determined to be located on a selectable item, then at a block 114, the processing device records the amount of time the cursor is located in a region associated with the selectable item. At a block 118, the processing device presents on the display a dwell indicator in or around the region of the selectable item based on the recorded time after an initial time period has lapsed. In one embodiment, the initial time period is zero seconds. Next at a decision block 120, the processing device determines if the dwell indicator or the recorded amount of time has reached a selection threshold. If the dwell indicator has not determined to have reached the threshold, the process 100 continues to record the amount of time the cursor is located in the region associated with the selectable item, or at which time the cursor is moved away from the region associated with the selectable item. If the dwell indicator or recorded amount of time has reached the threshold, the item is selected, see block 122.

In another preferred embodiment, a visual representation of dwell time for the cursor is used to assist a single-switch user in controlling the scan more directly. In this method, rather than allowing a scanning highlight (e.g. if the v-key is in highlight, it is colored different than adjacent keys) to move from item to item automatically, the user advances the highlight with a switch (as in two-switch scanning). Once the highlight arrives at the desired item, the user pauses and the item begins to “fill up” with a dwell indicator. If the user then clicks the switch at any time while the item is filling via the dwell indicator, a selection is made. If the dwell indicator reaches the top (or end) of the item without the user clicking their switch, no selection is made, in which case the user may continue advancing the scan highlight by clicking their switch.

In an alternative embodiment, a selection action takes place when the dwell indicator reaches the top (or end) of the item. If the user clicks their switch during the “fill” process, the scan highlight advances without a selection being made.

In another embodiment, an audible cue is provided and outputted through a speaker, either in conjunction with the visual cue or instead of it. A user-settable option provides for auditory feedback to accompany the visual representation of the dwell time. As the cursor enters each key boundary, a tone is played which corresponds to the fill level of that key. As the fill level of the key increases, so does the tone (and visa versa). When a key is selected, an audible “click” is played.

As an augmentation or alternative to the visual fill feedback mechanism, an audible tone may also be emitted (typically a rising tone). The tone may be a spoken utterance of the letter being dwelled upon, but with a rising tone such as in song. Geeee/ (for the letter “G”).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A computer program product residing on a computer-readable medium for selecting items on a display, the computer program product comprising:
a first component configured to record time at least one of a displayed cursor or highlight is located in or at a region associated with a selectable item;
a second component configured to generate an indicator based on the recorded amount of time; and
a third component configured to output the generated indicator on the display within the region associated with the selectable item.

2. The computer program product of claim 1, further comprising a fourth component configured to receive control signals from at least one of a pointing device or one or more switches.

3. The computer program product of claim 1, wherein the second component maintains the indicator in a current state if the first component stops recording the time the at least one of a displayed cursor or highlight is located in or at a region associated with the selectable item.

4. The computer program product of claim 3, wherein the second component alters the indicator if a threshold time period has elapsed since the first component stopped recording the time.

5. The computer program product of claim 2, wherein the control signals include a highlight advance command based on activation of the one or more switches.

6. The computer program product of claim 1, further comprising a fourth component configured to select the selectable item when the generated indicator reaches a threshold.

7. The computer program product of claim 1, further comprising a fourth component configured to select the selectable item when an activation signal generated by a user interface device is received.

8. The computer program product of claim 1, wherein the generated indicator comprises an audible cue, and the third component is configured to output the audible cue via a speaker.

9. A graphical user interface executed by a computer system having a display for selecting items on the display, the graphical user interface comprising:
a first component configured to record time at least one of a displayed cursor or highlight is located in or at a region associated with a selectable item;
a second component configured to generate an indicator based on the recorded amount of time; and
a third component configured to output the generated indicator on the display within the region associated with the selectable item.

10. The graphical user interface of claim 9, further comprising a fourth component configured to receive control signals from at least one of a pointing device or one or more switches.

11. The graphical user interface of claim 9, wherein the second component maintains the indicator in a current state if the first component stops recording the time the at least one of a displayed cursor or highlight is located in or at a region associated with the selectable item.

12. The graphical user interface of claim 11, wherein the second component alters the indicator if a threshold time period has elapsed since the first component stopped recording the time.

13. The graphical user interface of claim 10, wherein the control signals include a highlight advance command based on activation of the one or more switches.

14. The graphical user interface of claim 9, further comprising a fourth component configured to select the selectable item when the generated indicator reaches a threshold.

15. The graphical user interface of claim 9, further comprising a fourth component configured to select the selectable item when an activation signal generated by a user interface device is received.
